(19) United States
(12) Patent Application Publication
(10) Pub. No.: US 2008/0180357 A1
(43) Pub. Date: Jul. 31, 2008

(54) PLASMA PROCESSING APPARATUS

(76) Inventors: Masatoshi KAWAKAMI, Kudamatsu (JP); Ryoji NISHIO, Kudamatsu (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/676,700

(22) Filed: Feb. 20, 2007

(30) Foreign Application Priority Data
Jan. 25, 2007 (JP) 2007-014807

(51) Int. Cl. G09G 3/28

(52) U.S. Cl. 345/60

(57) ABSTRACT

A plasma etching apparatus in which discharge instability due to insufficient DC grounding is prevented. A grounded circular conductor is provided as a DC grounding means in a vacuum processing chamber and a control means controls a DC bias power supply according to output value of a current monitor so that the current which flows from the circular conductor to the ground is around 0 A, thereby preventing discharge instability which might be caused by increased plasma space potential.

### CLAIM OF PRIORITY

The present invention application claims priority from Japanese application JP2007-014807 filed on Jan. 25, 2007, the content of which is hereby incorporated by reference into this application.

### FIELD OF THE INVENTION

The present invention relates to plasma processing apparatuses which process a sample to be processed, such as a semiconductor wafer in a vacuum vessel (or in a vacuum processing chamber).

### BACKGROUND OF THE INVENTION

In the manufacture of semiconductor devices, plasma processing apparatuses have been widely used at steps such as deposition and etching. In recent years, with the growing tendency toward highly integrated devices with microcircuit patterns or larger wafer diameters, higher performance has been demanded in plasma processing apparatuses. Particularly, as the materials of device components are diversified and etching recipes become more complicated, it is important to ensure that a plasma processing apparatus operates stably in mass production for an extended period.

For example, since a plasma processing apparatus uses plasma of a reactive gas such as fluoride, chloride or bromide, the vacuum processing chamber wall surface is chemically or physically eroded. Therefore, as many wafers are processed, the chemical composition inside the vacuum processing chamber or high-frequency propagation may gradually change, making long-term stable processing impossible. In addition, a eroded wall material of the vacuum processing chamber may chemically react with active radicals in the plasma, causing adhesion of foreign substances to the inner wall surface of the vacuum processing chamber. As etching is repeated, the adhesion of foreign substances to the inner wall becomes thicker and at worst may peel and fall on a wafer, resulting in a defective product.

As a solution to this problem, an anodic oxide film (Al₂O₃, alumite) is made on the surface of the vacuum processing chamber inner member of the plasma processing apparatus which is exposed to plasma, by anodization, chemically stable treatment. The thickness of this alumite film is usually dozens of micrometers. However, alumite does not have sufficient plasma resistance and easily peels and when treated with fluoride, generates AlF. Since AlF is not a volatile gas, it is difficult to remove by cleaning discharge and may generate foreign substances.

Since plasma is generated by ionizing a neutral gas by discharge, the condition for neutrality, namely that the sum of negative charge (electrons and negative ions) and positive charge (ions) is always zero, should be satisfied. The generated negative charge and positive charge diffuse to the vacuum vessel wall and when the electrons and ions are recoupled on the wall surface, neutrality is restored. The vacuum vessel wall which surrounds the plasma is usually grounded in order to prevent electromagnetic wave leakage; however, if the wall is electrically conductive, upon recoupling the negative charge emits electrons to the wall and the positive charge receives electrons from the wall. In sum, neutrality is restored without the negative charge and positive charge meeting each other.

However, if the wall surface is made of an insulator such as alumite, charges which have diffused to the wall would be unable to exchange electrons with the wall. For this reason, if the wall is made of an insulating material, the positive charge and negative charge should meet on the wall surface in recoupling. If a pair of charges fail to meet, the charges are accumulated on the insulator surface. As a consequence, the electric potential of the insulator surface with positive or negative charges accumulated thereon increases or decreases and the potential distribution in the plasma changes. This changes the charge transportation condition in the plasma and prevents further accumulation of charges of a kind and urges attraction of pairs of charges. Eventually the insulator surface is charged up with a positive or negative potential (diffusion of positive charges to the insulator wall is equal to that of negative charges).

Abnormal discharge occurs in which electrons are emitted from a projection of the insulator surface toward the charged plasma.

This kind of charge-up on the insulator wall surface more often occurs in the case of a magnetized plasma source. This is because the mass of positive ions is extremely different from the mass of electrons and thus the amount of diffusion across a magnetic field is very different between positive ions and electrons, and positive and negative charges can not diffuse to the insulator wall equally. In this case, the potential of the insulator surface tends to rise until the effect of the magnetic field is negated on the insulator surface and positive and negative charges diffuse to the insulator surface equally. At this time, the alumite is not a perfect insulator and as the charge-up voltage increases, a very small leak current is generated. This effect limits the increase in the potential of the alumite surface to a certain level. However, if this rise of the potential should lead to an extremely high potential (for example, over 100 V), some incidental phenomena would occur.

First of all, as the potential distribution in the plasma changes, the plasma diffuses more and a phenomenon that the plasma spreads in pursuit of a conductive wall occurs. As the plasma spreads, it contacts the conductive wall and the rise of its potential is stopped. However, as soon as the rise of the plasma potential is stopped, the plasma ceases to spread and rapidly shrinks, then again a small plasma is generated and at the same time the plasma potential begins to rise again and the plasma spreads. In sum, the plasma may shrink and expand repeatedly, which is a phenomenon called plasma instability.

Furthermore, if the voltage between the insulator front surface and reverse surface (grounded conductor) exceeds the withstand voltage of the insulator, it may be that a discharge occurs in the insulator film and an electrically conductive path is formed, eliminating the charge-up by taking charges from the grounded conductor wall. This is a phenomenon called abnormal discharge, which causes scattering or evaporation of a wall material. A scattered wall material becomes foreign substances and an evaporated material may contaminate the product. This kind of abnormal discharge occurs in electrically weak parts of the insulator film and it is almost technically impossible to form a completely homogeneous insulator film and it is difficult to control this kind of abnormal discharge.

An abnormal discharge occurs not only in the above case but also can occur between positively and negatively charged insulator walls or occur on the insulator wall surface as a result of interaction with high frequencies for plasma generation.

Since the scale and frequency of the abovementioned phenomena such as plasma instability and abnormal discharge depend on the insulator wall condition, plasma instability and abnormal discharge vary even among apparatuses which are manufactured and operated under the same conditions. This leads to performance difference among apparatuses, a problem in mass production. Besides, the wall condition differs among apparatuses because different apparatuses have different experiences, which also poses an important problem related to deterioration over time.

In order to alleviate the problem of discharge instability, Japanese Patent Laid Open No. H11-185993 discloses a method whereby a positive voltage is applied to a circular conductor constituting part of an insulating vacuum vessel inner wall. This method limits the area of propagation of electromagnetic waves for plasma generation by forming an electron sheath on the conductor surface to prevent an abnormal discharge such as a hollow cathode discharge.

Also, Japanese Patent Laid Open No. 2005-183833 discloses a system in which a DC grounding means made of a conductive material is disposed at a location where the plasma floating potential (or plasma density) is higher than the plasma floating potential (or plasma density) at a location near a wafer holding electrode with a relatively large wall cut. Since this system can generate homogeneous plasma efficiently, it is thought to provide a capacitively coupled plasma processing apparatus which ensures a high in-plane homogeneity in plasma processing and hardly causes charge-up damage.

On the other hand, Japanese Patent Laid Open No. 2006-186323 discloses a system in which a grounding member is disposed near the bottom of a plasma generating region R so that an electric current flows from plasma in the plasma generating region R to the grounding member to make the plasma density uniform.

Also, in the apparatus disclosed in U.S. Pat. No. 7,086,347B2, a plasma processing chamber includes a grounding arrangement coupled to a plasma-facing component and the grounding arrangement includes a first resistance circuit disposed in a first current path between the plasma-facing component and the ground terminal. The resistance value of the first resistance circuit is selected to substantially eliminate arching between the plasma and the plasma-facing component during the processing of the substrate.

In recent years, with the growing tendency toward microcircuit patterns, the unfavorable influence of minute foreign substances on the yield has not been negligible and more emphasis has been placed on removal of foreign substances. For this reason, yttrium oxide (yttria, Y₂O₃), which is chemically stable and thus plasma-resistant and hardly causes generation of foreign substances, has been used as an inner surface material of the vacuum processing chamber. Usually an yttria film is formed on a metal material by thermal spraying and its thickness is several hundreds of micrometers. However, change of the material of the inner wall of the vacuum processing chamber from alumite to yttria increases the insulation performance of the wall and decreases the area of DC grounding. Therefore, the abovementioned phenomena such as plasma instability and abnormal discharge have become more emerging problems.

Insufficient DC grounding due to change of the inner wall surface material from alumite to yttria causes plasma charge-up because of absence of means of escape from the plasma. Consequently the space potential of the plasma goes up, which in turn leads to discharge instability, resulting in arching at a part of the vacuum vessel inner wall which is low in withstand voltage. In addition, oxide insulator such as yttria has a high electron-releasing ability and may cause such an abnormal discharge that electrons are released from a projection of the insulator surface toward charged-up plasma.

Abnormal discharge from an insulator wall and plasma instability, which have been existing problems, are more serious problems at present.

According to Japanese Patent Laid Open No. H11-185993, the reason that a better plasma is generated by making the potential of the circular conductor higher than the plasma space potential is that “when the potential of the circular conductor is higher than the plasma space potential, an electron sheath is formed near the surface of the circular conductor and when the potential of the circular conductor is lower, an ion sheath which has served as a path for electromagnetic wave propagation perishes.” Nevertheless, in order to form an electron sheath, an electron current must be concentrated on an electrode to which a positive voltage is applied. In order to satisfy the above conditions for neutrality, it is necessary to provide another conductor which enables a charge to pair with the electron current, namely an ion current, to flow in a concentrated manner. The method disclosed in Japanese Patent Laid Open No. H11-185993 is a technique which presupposes the existence of a conductive wall which can absorb a sufficient ion current for an electrode to which a positive voltage is applied. This technique is irrelevant to recent problems associated with increased insulation performance of an inner wall of a plasma processing apparatus for microcircuit patterns, namely abnormal discharge and plasma instability due to insufficient DC grounding.

In systems which include a DC grounding means as disclosed in Japanese Patent Laid Open No. 2005-183833, Japanese Patent Laid Open No. 2006-186323, and U.S. Pat. No. 7,086,347B2, a current flows from plasma through a DC grounding means but the space potential of the plasma is not controlled to become a specific potential. As the insulation performance of the plasma processing apparatus inner wall is increased, the plasma space potential becomes very susceptible to even the slightest environmental change in the vacuum processing chamber and may easily exceed 100 V when the plasma does not contact the DC grounding means. In such circumstances, simply by providing a DC grounding means, it is impossible to prevent the increase in the plasma space potential and achieve plasma stabilization.

### SUMMARY OF THE INVENTION

An object of the present invention is to provide a plasma processing apparatus and a plasma processing method which address the above problems of abnormal discharge and plasma instability due to insufficient DC grounding and suppress the increase in plasma space potential to prevent discharge instability.

According to the present invention, a plasma processing apparatus has a vacuum processing chamber with a plasma-resistant protective film formed on a wall surface supposed to contact plasma and generates plasma in the vacuum processing chamber to process a wafer. The apparatus includes: a conductor part located in a way to contact plasma in the vacuum processing chamber; and a potential control unit which controls potential of the conductor part to make it lower than space potential of the generated plasma. The potential control unit includes a DC power supply connected with the conductor part.

According to the present invention, a grounded conductor is disposed in a vacuum processing chamber as a DC grounding means and the current which flows from the conductor part to the ground is controlled to be kept around 0 A so that discharge instability which might be caused by increased plasma space potential is prevented. This in turn prevents abnormal discharge or generation of foreign substances attributable to discharge instability, thereby offering an advantage that the plasma processing apparatus operates stably in mass production for an extended period.

### BRIEF DESCRIPTION OF THE DRAWINGS

The invention will be more particularly described with reference to the accompanying drawings, in which:

FIG. 1 is a sectional view showing a plasma processing apparatus according to a first embodiment of the present invention;

FIG. 2 is a schematic view showing the location of a circular conductor according to the first embodiment of the present invention;

FIG. 3 is a schematic view showing the location of the circular conductor with a magnetic field applied in the plasma processing apparatus according to the first embodiment of the present invention;

FIG. 4 is a current-voltage characteristic curve graph for the circular conductor in the plasma processing apparatus according to the present invention;

FIG. 5 is a schematic view showing a current flow from plasma to the ground with a magnetic field applied in the plasma processing apparatus according to the first embodiment of the present invention;

FIG. 6 is a first schematic view showing the vicinity of the circular conductor in the plasma processing apparatus according to the first embodiment of the present invention;

FIG. 7 is a second schematic view showing the vicinity of the circular conductor in the plasma processing apparatus according to the first embodiment of the present invention;

FIG. 8 is a first schematic view showing the vicinity of a circular conductor and a circular insulator in a plasma processing apparatus according to a second embodiment of the present invention;

FIG. 9 is a second schematic view showing the vicinity of a circular conductor and a circular insulator in the plasma processing apparatus according to the second embodiment of the present invention;

FIG. 10 is a schematic sectional view showing a plasma processing apparatus according to a third embodiment of the present invention;

FIG. 11 is a schematic sectional view showing a plasma processing apparatus according to a fourth embodiment of the present invention;

FIG. 12 is a schematic sectional view showing a plasma processing apparatus according to a fifth embodiment of the present invention; and

FIG. 13 is a schematic sectional view showing a plasma processing apparatus according to a sixth embodiment of the present invention.

### DETAILED DESCRIPTION OF THE PREFERRED EMBODIMENTS

Next, preferred embodiments of the present invention will be described referring to the accompanying drawings.

### First Embodiment

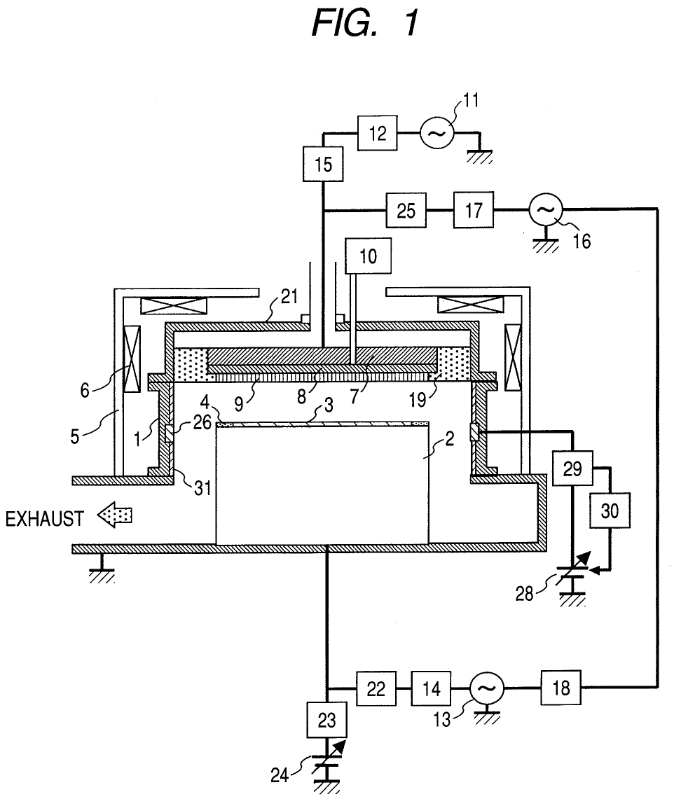

The first embodiment of the present invention will be described referring to FIGS. 1 to 5 below.

First, FIG. 1 is a sectional view showing a plasma processing apparatus according to the first embodiment of the present invention. The plasma processing apparatus includes: a vacuum processing chamber 1; a lower electrode 2, located in the vacuum processing chamber 1 and provided with a sample holding surface for holding a sample (such as a wafer) 3 to be processed thereon; an upper electrode 9, located opposite to the lower electrode 2 and provided with a part of a conductive material to contact plasma; a high frequency power source for the upper and lower electrodes; a magnetic field generating means; and a processing gas supply system. A focus ring 4 is provided around the sample holding surface of the lower electrode 2. The magnetic field generating means includes yokes 5 and coils 6. The processing gas supply means includes a gas supply system 10 and a gas dispersion plate 8. The vacuum processing chamber 1 is connected with a vacuum pump which depressurizes and evacuates the vacuum processing chamber. The high frequency power source includes: an antenna 7; a first high frequency power supply 11; a first matching box 12; a second high frequency power supply 13; a second matching box 14; a first filter circuit 15; a third high frequency power supply 16; a third matching box 17; a phase adjusting unit 18; an antenna outer ring 19; an antenna cover 21; a second filter circuit 22; and a third filter circuit 25. The lower electrode 2 is connected through a fourth filter circuit 23 to an electrostatic chuck power supply 24. The vacuum processing chamber 1 further includes a plasma potential control unit which controls the plasma potential of the wall of the vacuum processing chamber. The side walls of the vacuum processing chamber 1 which are supposed to contact plasma have a double wall structure with an inner and an outer wall, where the outer wall of each side wall is made of metal, for example, aluminum and the inner wall of the side wall constitutes a plasma-resistant protective film. More specifically, the inner wall is composed of a conductor part (circular conductor) 26, and insulating films 31 with the circular conductor between them. The plasma potential control unit, connected between the circular conductor 26 of the inner wall and the ground, constitutes a DC grounding means and has the function of giving the circular conductor 26 a voltage lower than the plasma space potential. The plasma potential control unit includes a DC bias power supply 28, a current monitor 29, and a control means 30.

In the apparatus constituted as mentioned above, after depressurization of the inside of the vacuum processing chamber 1, an etching gas is introduced into the vacuum processing chamber by the gas supply system 10 and the pressure is adjusted to a desired level. A magnetic field is generated between the lower electrode 2 and the upper electrode 9 in the vacuum processing chamber 1 by the coils 6 and yokes 5 of the magnetic field generating means. Then, high frequency power (for example, 200 MHz) generated by the first high frequency power supply 11 of the high frequency power source is fed into the vacuum processing chamber 1 through the antenna 7 and the antenna outer ring 19. The electric field of the high frequency power fed into the vacuum processing chamber 1 generates a high-density plasma inside the vacuum processing chamber by interaction with the magnetic field generated in the vacuum processing chamber. Especially, when a magnetic field intensity which is enough for an electron cyclotron resonance to occur (for example, approx. 70 G when the frequency of the high frequency power source for plasma generation is 200 MHz) is generated between the lower electrode 2 and the upper electrode 9 in the vacuum processing chamber 1, a high-density plasma is generated efficiently.

In this apparatus, the first high frequency power supply 11 (200 MHz) mainly generates plasma, the third high frequency power supply 16 controls the plasma composition or plasma distribution, and the second high frequency power supply 13 controls the energy of ions in the plasma entering a sample. The plasma potential control unit adjusts the potential of the circular conductor 26 to a voltage lower than the plasma space potential and thereby controls the current flowing from the plasma to the ground to make it around 0 A so that the plasma space potential is stable.

A sample transport system (not shown) carries a wafer 3 onto the sample holding surface of the sample-holding lower electrode 2 and after plasma generation with the above procedure, the third high frequency power supply 16 and the second high frequency power supply 13 respectively feed high frequency power to the upper electrode 9 and the sample-holding lower electrode 2 to etch the wafer 3.

At this time, the phase adjusting unit 18 controls the phase of the second high frequency power supply 13 and that of the third high frequency power supply 16 so that the phases are opposite to each other. The electrostatic chuck power supply 24 applies several hundreds of volts DC to hold the wafer on the sample holding surface by electrostatic force.

The side wall surface (inner wall surface) of the vacuum processing chamber 1 is comprised the insulating film 31 and the circular conductor 26. Any insulator may be used for the insulating film 31 but the use of Y₂O₃, SiO₂, SiC, or insulator ceramic including carbide or oxide such as boron carbide or alumite or nitride is preferable.

High frequency bias currents supplied to the upper electrode 9 and the sample-holding lower electrode 2 are controlled by the phase adjusting unit 18 so as to make their phases opposite to each other, thereby preventing the plasma space potential from going up.

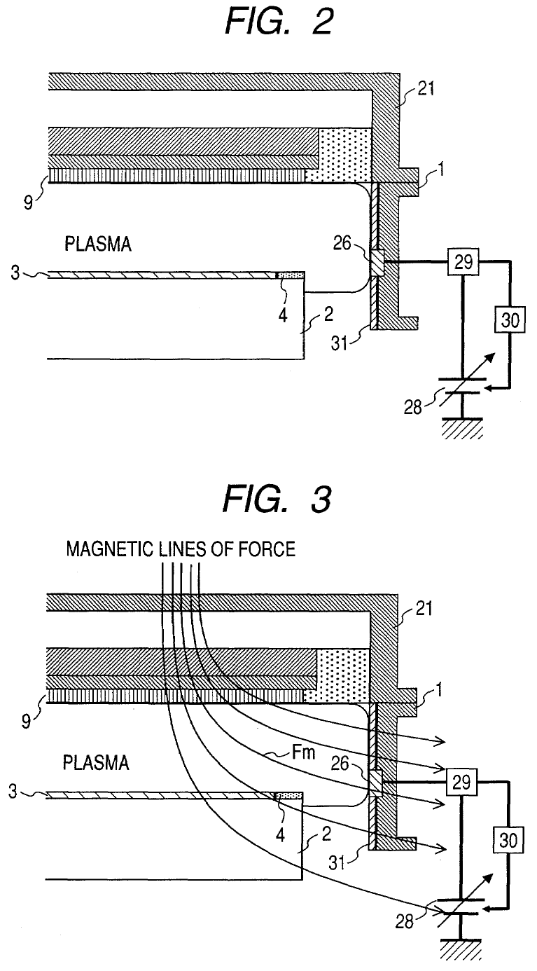

As shown in FIG. 2, in order to enable a direct current from plasma to flow through the side wall of the vacuum processing chamber 1 into the DC grounding means, the circular conductor 26 is located in a way to contact the plasma in the vacuum processing chamber directly.

Controlled DC bias power from the DC bias power supply 28 is applied to the circular conductor 26 through the current monitor 29. Potential E_{c} of the DC bias power supply 28 is controlled according to output of the current monitor 29 by the control means 30. This controls the potential of the circular conductor 26 to make it lower than the plasma space potential.

In the present invention, since DC current flows from the plasma to the ground, the problem of plasma charge-up is resolved, which prevents the plasma space potential from going up.

For resolution of the problem of plasma charge-up, an excess current which might cause charge-up should flow as a direct current from the plasma through the circular conductor 26 to the ground. In order to ensure that a direct current flows as mentioned above, the potential of the circular conductor 26 should be lower than the plasma space potential.

FIG. 3 is a schematic view showing the relation between the location of the circular conductor 26 and magnetic lines of force, with a magnetic field applied in the plasma processing apparatus according to the invention. The circular conductor 26 is on a magnetic line of force generated by the magnetic field generating means, preferably major lines with a large magnetic force Fm among a group of magnetic lines (hereinafter simply called the major magnetic lines), provided that those magnetic lines are so located that any other component does not interrupt it between the upper electrode 9 and the circular conductor 26 in the vacuum processing chamber 1. For example, the circular conductor 26 may be located sideward in the space between the lower electrode 2 and the upper electrode 9, more specifically slightly below the side of the focus ring 4.

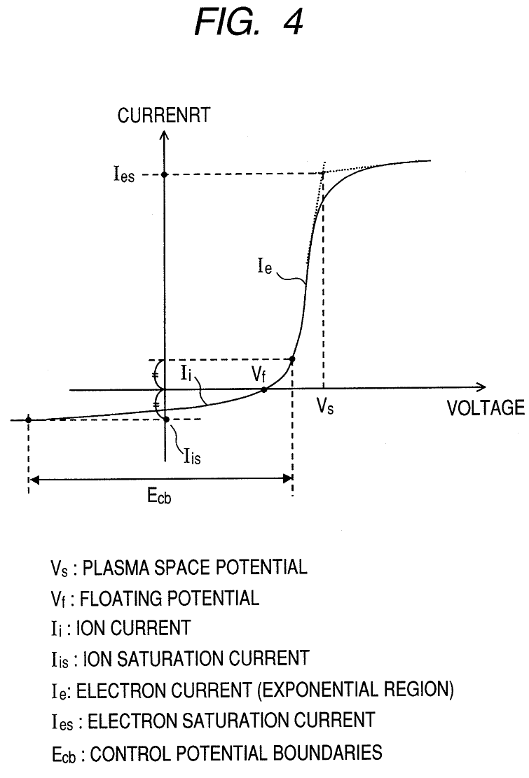

FIG. 4 shows a current-voltage characteristic curve for the circular conductor 26 in contact with plasma. As shown in FIG. 4, electron current Iₑ rises exponentially in the range from floating potential V_{f} to plasma space potential Vₛ, leading to a large current flow. Beyond plasma space potential Vₛ, the electron current reaches the level of saturation current Iₑₛ. If the apparatus is used with electron current Iₑ at the level of saturation current Iₑₛ, there would arise such a problem that a load is added to the circular conductor 26 because of the above large current or that a power source or wiring which deals with such a large current is needed. For this reason, it is desirable that the potential of the circular conductor 26 be lower than the plasma space potential Vₛ, more preferably around or below floating potential V_{f}. When it is around floating potential V_{f}, the current which flows from the plasma to the ground is kept at a low level. As can be understood from FIG. 4, currents in the region where the potential is lower than floating potential V_{f} are in a region around 0 A. Here, a current around 0 A should be considered to be within the absolute value of ion saturation current Iᵢₛ.

In the present invention, the current monitor 29 monitors the current flowing from the circular conductor 26 to the DC grounding means and the control means 30 controls the potential E_{c} of the DC bias power supply 28 to a level lower than plasma space potential Vₛ, more preferably to within potential boundaries (=E_{cb}) corresponding to currents within the absolute value of ion saturation current Iᵢₛ so that the current is below the exponential region, more preferably within the absolute value of ion saturation current Iᵢₛ. The absolute value of ion saturation current Iᵢₛ is set by the control means 30.

If the potential of the circular conductor 26 should be higher than the plasma space potential, an electron sheath would be formed adjacent to the surface of the circular conductor as described in Japanese Patent Laid Open No. H11-185993 and consequently, if the space potential should rise beyond 100 V, a large current would flow from the plasma to the ground. If such a situation may arise, the plasma space potential would become unstable and the DC grounding means should be designed to withstand such a large current or large power. In the present invention, since the current which flows through the DC grounding means is controlled to be kept to a small current value, or around 0 A, this kind of problem will not occur though the apparatus can be inexpensive.

It is desirable that the upper electrode 9 and the circular conductor 26 are not interrupted by any obstacle and are connected by a magnetic line of force, preferably the major magnetic lines of force.

In the present invention, to ensure that DC current can flow from the plasma into the circular conductor 26 when a magnetic field is applied, the circular conductor 26 is located in a way to contact the plasma directly and be connected with the conductive upper electrode 9 by a magnetic line of force, preferably a major magnetic line of force.

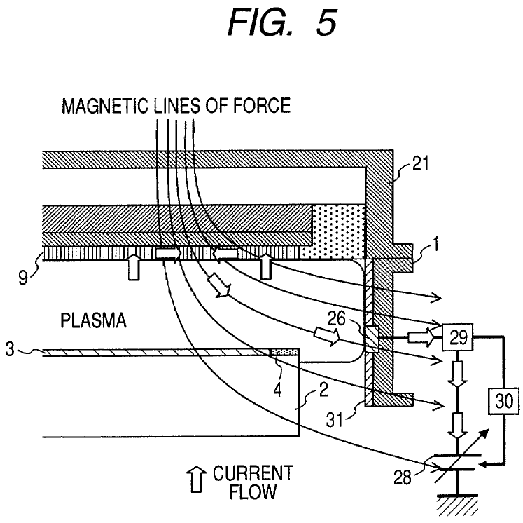

FIG. 5 shows a current flow with magnetic lines of force. The arrows and accompanying numerals indicate the directions of current flows. Regarding charge movement in the plasma, generally ions move across magnetic lines of force and electrons move along magnetic lines of force. Electrons, which are supplied from the circular conductor 26, flow along magnetic lines of force in a direction opposite to the current flow. In other words, DC current flows from the plasma to the upper electrode 9, then DC current flows from the upper electrode 9 along magnetic lines of force to the circular conductor 26. Then, current flows from the circular conductor 26 through the bias power supply 28 to the ground. If charge-up occurs, this resolves the difference between electrons and ions in the plasma. For example, in the case of an imbalance that the plasma contains more ions than electrons, while the plasma space potential might rise substantially in the related art, in this embodiment electrons supplied from the circular conductor 26 smoothly flow along magnetic lines of force to the plasma in a direction opposite to the current flow and thus an imbalance between electrons and ions is instantly resolved. This prevents the plasma space potential from going up and keeps it at a level lower than the plasma space potential Vs. This means that a substantial increase in the plasma space potential is prevented and abnormal discharge is reduced and plasma stability is ensured.

In this case as well, the current flowing from the circular conductor 26 to the ground is monitored by the current monitor 29 and the control means 30 controls potential E_{c} of the DC bias power supply 28 within potential boundaries (=E_{cb}) so that this current is kept around 0 A.

By controlling potential E_{c} of the DC bias power supply 28, it is possible to ensure that DC current flows from the plasma to the ground, and resolve the problem of plasma charge-up and reliably prevent the space potential from going up.

Here, a non-circular conductor may be used instead of the circular conductor 26. For example, a conductor may be divided into several pieces which are then arranged in a circular pattern. Such a circular arrangement of conductor pieces is more desirable in terms of cost performance.

In addition, it is desirable that the conductor part of the circular conductor 26 be as wide as possible because as it is wider, sputtering is more difficult to be concentrated. Furthermore, any conductive material may be used as the material of the conductor part but it is desirable to use Si, SiC, conductive ceramic, Al or Al compound.

Also, from the viewpoint of cost performance, it is desirable the conductor part be replaceable.

According to this embodiment, a grounded conductor constituting part of the inner wall of the vacuum processing chamber is provided as a DC grounding means and the current which flows from the conductor to the ground is controlled to be kept around 0 A so that discharge instability which might be caused by increased plasma space potential is prevented. This in turn prevents abnormal discharge or generation of foreign substances due to discharge instability, thereby offering an advantage that the plasma processing apparatus operates stably in mass production for an extended period.

### Second Embodiment

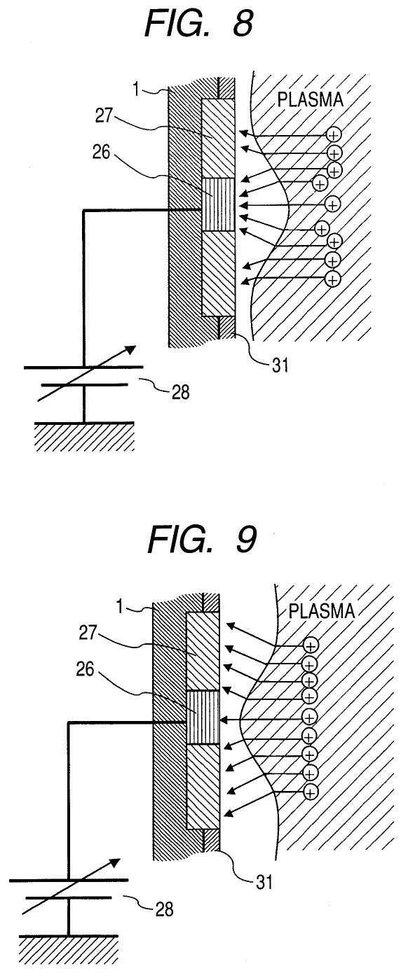

Next, an improved version of the plasma processing apparatus in the first embodiment according to a second embodiment will be described referring to FIGS. 8 and 9.

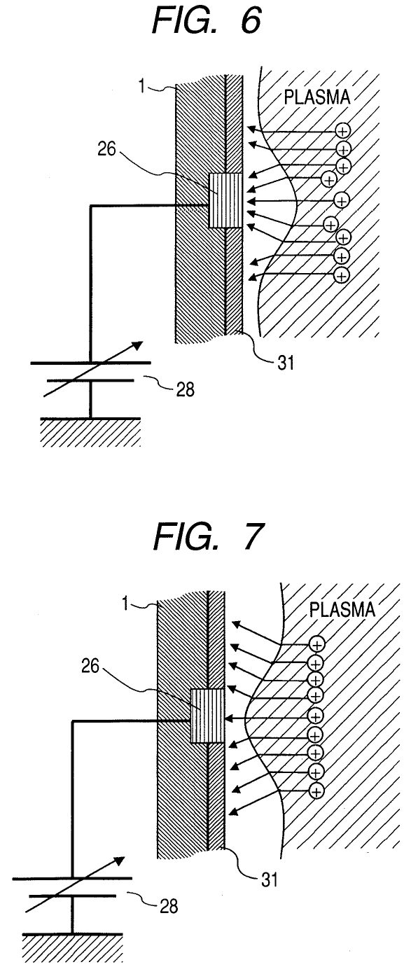

First, the problem of the first embodiment is explained below. When a conductor part like the circular conductor 26 is used, the thickness of the ion sheath adjacent to the conductor part varies as shown in FIGS. 6 and 7. There are two ways of thickness change: the ion sheath portion on the conductor part is thicker (FIG. 6) or thinner (FIG. 7) than the ion sheath portion on the wall.

This is because the ion sheath thickness varies in proportion to the floating potential ratio raised to the ¾th power with respect to the conductor part. In the former and latter cases, the conductor part and the area around it are sputtered by ions. Particularly in the case of FIG. 6 that the sheath becomes thinner, the trajectory of incident ions curves in a way to spread more toward peripheral directions and thus the area around the conductor part is extensively sputtered.

For the above reason, it is more desirable that the area around the conductor part which is to be sputtered be a replaceable part separate from the chamber inner wall.

Therefore, according to the second embodiment as an improved version of the first embodiment, replaceable circular insulators 27 as parts separate from the chamber inner wall are fitted above and below the conductor part such as the circular conductor 26, and the insulating film 31 is fitted above and below the insulators.

In the second embodiment as well, as the ion sheath thickness of the area around the conductor part changes, the conductor part and the area around it are sputtered by ions. Due to the presence of the replaceable circular insulators 27 around the conductor part, the problem associated with sputtering is addressed by replacing only the conductor part and the circular insulators 27 while leaving the insulating film 31 intact. Since the required frequency of replacement often differs between the conductor part 26 and the circular insulators 27, it is desirable that they can be replaced separately.

Any insulator may be used for the circular insulators 27 but the use of Y₂O₃, SiC or insulating ceramic including carbide or oxide such as boron carbide or alumite or nitride is preferable.

In this case, for example, if the plasma electron density is 10¹¹ cm⁻³ and the plasma electron temperature is 3 eV and the voltage applied to the conductor part 26 is −100 V, the sheath thickness is 0.5 mm or so. When the circular insulators 27 are 10-40 times wider than the sheath, they can cover the area where incident ions spread. Therefore, it is desirable that the vertical size of the circular insulators 27 be 5-20 mm.

If a circular arrangement of conductor pieces is used instead of the circular conductor part, it is desirable that replaceable insulators be circularly arranged around them similarly.

The use of replaceable parts separate from the chamber inner wall around the conductor part offers an advantageous effect that the plasma processing apparatus with a plasma-resistant protective film formed on the vacuum processing chamber wall supposed to contact plasma can operate stably in mass production for an extended period.

### Third Embodiment

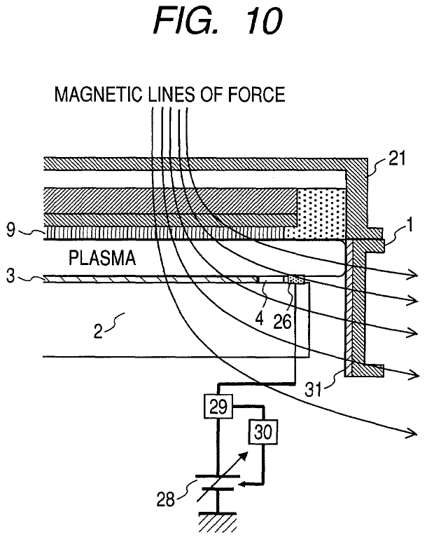

A plasma processing apparatus according to a third embodiment of the present invention will be described referring to FIG. 10. FIG. 10 is a schematic sectional view showing the plasma processing apparatus according to the third embodiment.

Although in the foregoing embodiments the conductor part is fitted to the side wall of the vacuum processing chamber, the location of the conductor part is not limited thereto. The conductor part may be located anywhere as far as it can contact plasma. When a magnetic field is applied during processing, it is sufficient if the conductor 26 is connected with the upper electrode 9 by magnetic lines of force without being interrupted by any obstacle. This means that it need not be fitted to the side wall inside the vacuum processing chamber.

For example, it may be fitted to a ceiling surface which can contact plasma in the vacuum processing chamber. Alternatively, as in this embodiment (FIG. 10), the conductor 26 may be located on the periphery of the lower electrode 2, for example outside the focus ring 4 in a way to contact plasma. In this case as well, it is desirable that the conductor 26 be connected with the upper electrode 9 by magnetic lines with a large magnetic force without being interrupted by any obstacle.

When a magnetic field is applied, if there are few magnetic lines of force or the distance between the upper electrode and the lower electrode is small, it is more desirable to fit the conductor to the periphery of the lower electrode than to the vacuum processing chamber inner wall because the upper electrode and the conductor can be more easily connected by the magnetic lines of force without being interrupted by any obstacle.

According to this embodiment, a grounded conductor constituting part of the inner wall of the vacuum processing chamber is provided as a DC grounding means and the current which flows from the conductor to the ground is controlled to be kept around 0 A so that discharge instability which might be caused by increased plasma space potential is prevented. This in turn prevents abnormal discharge or generation of foreign substances due to discharge instability, thereby offering an advantage that the plasma processing apparatus operates stably in mass production for an extended period.

### Fourth Embodiment

Next, a plasma processing apparatus according to a fourth embodiment of the present invention will be described.

The foregoing embodiments assume a plasma processing apparatus in which a magnetic field is applied during processing of a specimen; however the present invention is not limited thereto. Even in an apparatus without a magnetic field, it is possible to prevent the plasma space potential from going up by fitting a conductor part so that it can contact plasma. In other words, according to the present invention, in any plasma processing apparatus that generates plasma in a vacuum processing chamber by evacuating the vacuum processing chamber while supplying process gas to the vacuum processing chamber and emitting electromagnetic waves into the vacuum processing chamber while keeping the vacuum processing chamber inner pressure at a prescribed level and processes a wafer placed on an electrode in the vacuum processing chamber, a grounded conductor part is fitted to part of the inner wall or the like of the vacuum processing chamber as a DC grounding means and the current which flows from the conductor part to the ground is controlled to be kept around 0 A.

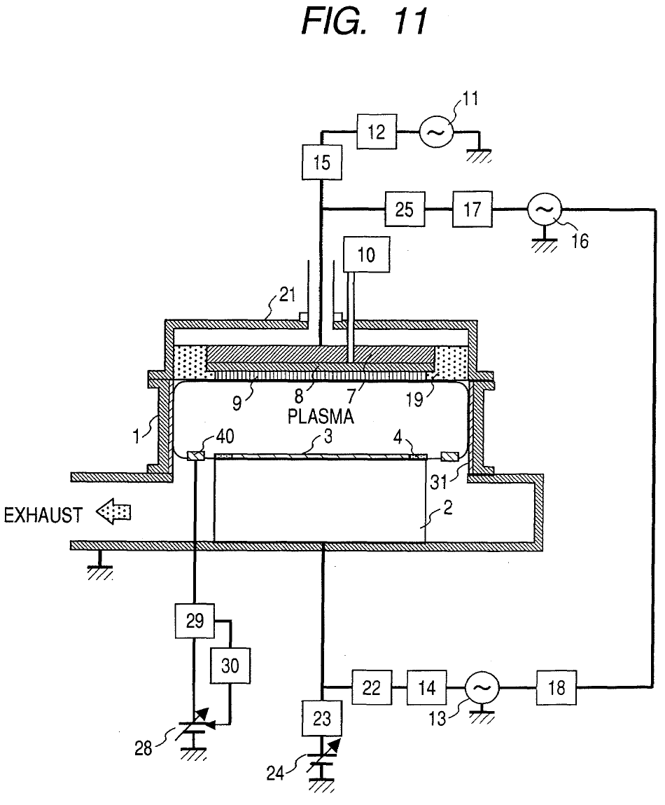

FIG. 11 is a schematic sectional view showing a plasma processing apparatus according to the fourth embodiment. In the case of FIG. 11, a plasma contact conductor 40 including a circular conductor part is located outside a lower electrode 2 which can movable up and down in the vacuum processing chamber.

In this embodiment as well, the plasma potential control unit which controls the potential of the plasma contact conductor 40 includes a DC bias power supply 28, a current monitor 29, and a control means 30 where their functions are the same as in the foregoing embodiments. Specifically the current monitor 29 monitors the current flowing from the plasma contact conductor 40 to the DC grounding means and the control means 30 controls the potential E_{c} of the DC bias power supply 28 to a level lower than plasma space potential Vₛ, more preferably to within potential boundaries (=E_{cb}) corresponding to currents within the absolute value of ion saturation current Iᵢₛ so that the current is below the exponential region, more preferably within the absolute value of ion saturation current Iᵢₛ.

In this embodiment, while electrons move freely not subject to the influence of magnetic lines of force, they flow into a DC grounding means in contact with plasma and an imbalance between electrons and ions is quickly resolved. This prevents the plasma space potential from going up and keeps it at a level lower than the plasma space potential Vₛ. This means that a substantial increase in the plasma space potential is prevented and abnormal discharge is reduced and plasma stability is ensured.

### Fifth Embodiment

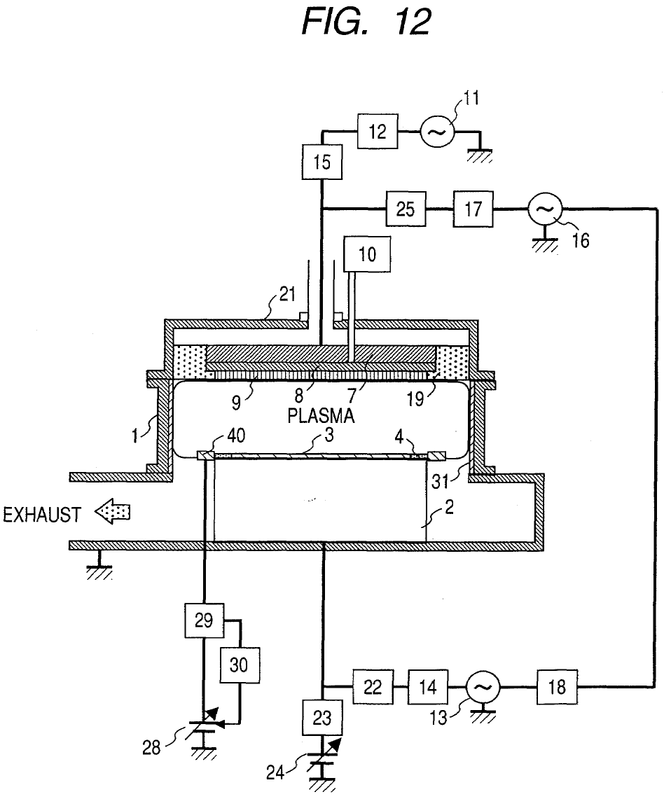

Next, a plasma processing apparatus according to a fifth embodiment of the present invention will be described referring to FIG. 12. FIG. 12 is a schematic sectional view showing a plasma processing apparatus according to the fifth embodiment.

In the case of FIG. 12, a plasma contact conductor 40 including a circular conductor part is located on the side edge of a lower electrode 2 in the vacuum processing chamber. The constitution and function of the plasma potential control unit are the same as in the foregoing embodiments. In this embodiment as well, electrons flow into a DC grounding means and an imbalance between electrons and ions is resolved, thereby preventing the plasma space potential from going up and keeping it at a level lower than the plasma space potential Vₛ. This means that a substantial increase in the plasma space potential is prevented and abnormal discharge is reduced and plasma stability is ensured.

### Sixth Embodiment

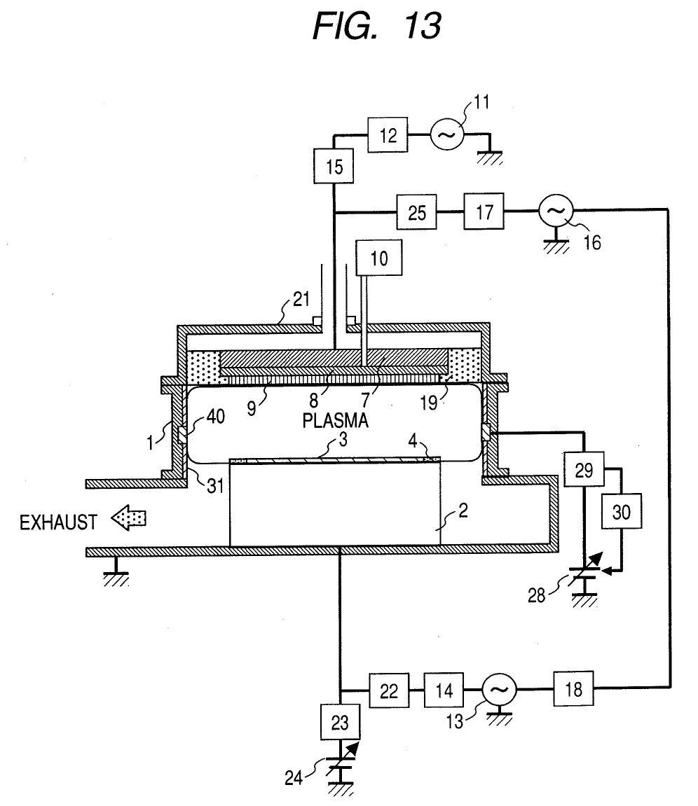

Next, a plasma processing apparatus according to a sixth embodiment of the present invention will be described referring to FIG. 13. FIG. 13 is a schematic sectional view showing a plasma processing apparatus according to the sixth embodiment.

In the case of FIG. 13, a plasma contact conductor 40 including a circular conductor part is fitted to the inner wall of the vacuum processing chamber. The constitution and function of the plasma potential control unit are the same as in the foregoing embodiments. As in the second embodiment, a replaceable insulator may be disposed around the conductor part. In this embodiment as well, electrons flow into a DC grounding means and an imbalance between electrons and ions is resolved, thereby preventing the plasma space potential from going up and keeping it at a level lower than the plasma space potential Vₛ. This means that a substantial increase in the plasma space potential is prevented and abnormal discharge is reduced and plasma stability is ensured.

What is claimed is:

1. A plasma processing apparatus which has a vacuum processing chamber with a plasma-resistant protective film formed on a wall surface supposed to contact plasma and generates plasma in the vacuum processing chamber to process a sample, comprising:
a conductor part located in a way to contact plasma in the vacuum processing chamber; and
a plasma potential control unit which controls potential of the conductor part to make it lower than space potential of the generated plasma,
wherein the plasma potential control unit includes a DC power supply connected with the conductor part.

2. The plasma processing apparatus according to claim 1,
wherein the plasma potential control unit has a function of controlling potential of the conductor part to make it equal to or lower than floating potential of the generated plasma.

3. The plasma processing apparatus according to claim 1,
wherein the plasma potential control unit constitutes a DC grounding means which connects the conductor part to the ground.

4. The plasma processing apparatus according to claim 1,
wherein the plasma potential control unit includes:
the DC power supply which applies a negative DC voltage to the conductor part;
a current monitor which measures a current flowing from the conductor part to the ground; and
a control means which controls voltage of the DC power supply to ensure that the monitored current value is around 0 A.

5. The plasma processing apparatus according to claim 4,
wherein the plasma potential control unit controls voltage of the DC power supply using an absolute value of saturation region Iᵢₛ of ion saturation current Iᵢ to ensure that the current value around 0 A is within the absolute value of Iᵢₛ.

6. The plasma processing apparatus according to claim 1,
wherein the conductor part is located on a side wall of the vacuum processing chamber on which the plasma-resistant protective film is formed.

7. The plasma processing apparatus according to claim 1, further comprising:
a lower electrode for a sample to hold on, located in the vacuum processing chamber,
wherein the conductor part is located on the periphery of the lower electrode.

8. The plasma processing apparatus according to claim 1, further comprising:
a lower electrode for a sample to hold on, located in the vacuum processing chamber,
wherein the conductor part is located between the periphery of the lower electrode and a side wall of the vacuum processing chamber.

9. A plasma processing apparatus which has a vacuum processing chamber with a yttria protective film formed on a side wall, an upper electrode with a part of a conductive material supposed to contact plasma, a lower electrode, and an electrostatic power supply for holding a sample on the lower electrode by electrostatic force and generates plasma in the vacuum processing chamber to process a sample, comprising:
a conductor part located on a side wall of the vacuum processing chamber in a way to contact plasma; and
a plasma potential control unit which controls potential of the conductor part to make it lower than space potential of the plasma,
wherein the plasma potential control unit includes a DC power supply which applies a negative DC voltage to the conductor part.

10. The plasma processing apparatus according to claim 9,
wherein the plasma potential control unit has a function of controlling potential of the conductor part to make it equal to or lower than floating potential of the plasma.

11. The plasma processing apparatus according to claim 9,
wherein the plasma potential control unit includes:
a current monitor which measures a current flowing from the conductor part to the ground; and
a control means which controls voltage of the DC power supply to ensure that the monitored current value is around 0 A.

12. The plasma processing apparatus according to claim 9, further comprising an upper and a lower insulator part with the conductor part between them, the conductor part being located on the side wall of the vacuum processing chamber.

13. A plasma processing apparatus which has a vacuum processing chamber with a yttria protective film formed on a side wall, an upper electrode with a part of a conductive material supposed to contact plasma, a lower electrode, an electrostatic adsorption power supply for holding a sample placed on the lower electrode by electrostatic adsorption power, and a magnetic field generating means and generates plasma in the vacuum processing chamber to process a sample, comprising:
a conductor part located on a side wall of the vacuum processing chamber in a way to contact plasma; and
a DC power supply which applies a negative DC voltage to the conductor part,
wherein the conductor part is on a magnetic line of force generated by the magnetic field generating means and located in a way to ensure that the magnetic line of force is not interrupted between the upper electrode and the conductor part by another component.

14. The plasma processing apparatus according to claim 13, further comprising:
a plasma potential control unit which controls potential of the conductor part to make it lower than space potential of the plasma,
wherein the plasma potential control unit includes a DC power supply which applies a negative DC voltage to the conductor part.

15. The plasma processing apparatus according to claim 14,
wherein the plasma potential control unit controls potential of the conductor part to make it equal to or lower than floating potential of the plasma.

16. The plasma processing apparatus according to claim 14,
wherein the plasma potential control unit includes:
a current monitor which measures a current flowing from the conductor part to the ground; and
a control means which controls voltage of the DC power supply to ensure that the monitored current value is around 0 A.

17. The plasma processing apparatus according to claim 14, further comprising an insulator part for reducing sputtering of the side wall by ions which is located in the vicinity of the conductor part.

18. The plasma processing apparatus according to claim 17,
wherein the material of the conductor part is Si, SiC, conductive ceramic, Al, or Al compound; and
the material of the insulator part is Y₂O₃, SiC, or insulator ceramic including carbide or oxide such as boron carbide or alumite or nitride.
